(19) United States
(12) Patent Application Publication
(10) Pub. No.: US 2009/0114254 A1
(43) Pub. Date: May 7, 2009

(54) WINDOW CLEANING SYSTEM FOR WINDOWS OF A MOTOR VEHICLE

(76) Inventors: Manuel Jeppe, Rotenburg a.d. Fulda (DE); Winfried Munk, Melsungen (DE); Patrick Opel, Rotenburg (DE); Dirk Ringler, Friedewald (DE); Thomas Werner, Nentershausen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/263,550

(22) Filed: Nov. 3, 2008

(30) Foreign Application Priority Data
Nov. 5, 2007 (DE) 10 2007 052 644.1

(51) Int. Cl. B08B 3/04

(52) U.S. Cl. 134/34; 134/123

(57) ABSTRACT

In a window cleaning system for a motor vehicle, having a dual pump (2) and having a valve (7) which is switched by the dual pump (2), a pressure surge which is generated during the switching of the valve (7) is conducted into the dual pump (2). For this purpose, valve seats (22, 23) are connected to inlets (25, 26) of the valve (7). Conducting the pressure surge into the dual pump (2) prevents that, during the switching of the valve (7), washer fluid passes onto a window (15, 16) which is not to be sprayed.

### CROSS-REFERENCE TO RELATED APPLICATIONS

This application claims priority to German Patent Application No. 10 2007 052 644.1 filed Nov. 5, 2007, the contents of which is incorporated herein by reference in its entirety.

### TECHNICAL FIELD

The invention relates to a window cleaning system for windows of a motor vehicle, having a dual pump which can be driven in two rotational directions and having a valve which has a valve body which can be moved between two valve seats, having two washer fluid lines which are connected to the valve and which lead to washer nozzles, with it being selectively possible as a function of the rotational direction of the dual pump for a first window to be sprayed with washer fluid via the one washer nozzle or for a second window to be sprayed with washer fluid via the other washer nozzle.

### BACKGROUND

Window cleaning systems of said type are often used in modern-day motor vehicles for independently cleaning two windows, for example a front window and a rear window, or headlamp lenses, and are known from practice. Non-return valves are often arranged directly upstream of the washer nozzles, which non-return valves prevent washer fluid lines which are arranged between the valve and the washer nozzles from running dry. By using the dual pump which can be switched in two rotational directions, it is possible to separately clean different windows using only a single pump and, aside from the valve, without further control means. In the known valve, the valve body is designed as a movable diaphragm and bears against one of the valve seats. If the one side of the diaphragm is acted on with pressure from the dual pump, the diaphragm is moved away from the first valve seat and is pressed against the second valve seat.

A disadvantage of the known window cleaning system is however that the valve body, during its movement by the dual pump, displaces washer fluid before it is pressed against the second valve seat. Said washer fluid is fed in the form of a surge to the washer nozzle. Said pressure surge has an intensity which is sufficient to spray a splash of the washer fluid onto the window which is presently not to be supplied with washer fluid.

### SUMMARY

A window cleaning system of the type specified in the introduction can be refined in such a way as to prevent a splash on the window which is not to be supplied with washer fluid.

According to an embodiment, a window cleaning system for windows of a motor vehicle, may comprise a dual pump which is operable to be driven in two rotational directions and having a valve which has a valve body which is operable to be moved between two valve seats, and two washer fluid lines which are connected to the valve and which lead to washer nozzles, wherein the window cleaning system is operable depending on a function of the rotational direction of the dual pump to select between a first window to be sprayed with washer fluid via the one washer nozzle and a second window to be sprayed with washer fluid via the other washer nozzle, and wherein an impulse, which is generated during the movement of the valve body within the washer fluid situated in the valve, is directed away from the outlet.

According to a further embodiment, at least one of the valve seats can be arranged at an inlet which opens out from the dual pump into the valve. According to a further embodiment, the valve body can be arranged on the center of a diaphragm. According to a further embodiment, the inlets of the valve can be arranged so as to taper toward one another and can be directed at the center of the valve body. According to a further embodiment, at least one of the outlets of the valve can be connected to an annular calming duct and the calming duct surrounds the valve seat. According to a further embodiment, the valve body can be guided so as to be movable transversely with respect to the valve seat. According to a further embodiment, the valve seat may be arranged on a tube piece which projects into the valve and which has a closed base, and the valve body annularly surrounds the tube piece. According to a further embodiment, the valve body may tightly surround the tube piece and may be guided so as to be movable between a position in which the valve seat is opened and a position in which the valve seat is covered. According to a further embodiment, the tube piece which projects into the valve may have an encircling ramp as a valve seat.

### BRIEF DESCRIPTION OF THE DRAWINGS

The invention permits numerous embodiments. To further illustrate its basic principle, a plurality of said embodiments are illustrated in the drawing and are described below. In the drawing:

FIG. 1 schematically shows a window cleaning system according to an embodiment for a motor vehicle, in partial section,

FIG. 2 shows a section illustration through a valve for the window cleaning system according to the embodiment of FIG. 1,

FIG. 3 shows a further embodiment of the valve for the window cleaning system according to the embodiment of FIG. 1,

FIG. 4 shows the valve from FIG. 3 with the valve body moved,

FIG. 5 shows a further embodiment of the valve for the window cleaning system according to FIG. 1,

FIG. 6 shows the valve from FIG. 5 with the valve body moved.

### DETAILED DESCRIPTION

By means of the design according to various embodiments, a pressure impulse which is generated during the switching of the valve is conducted into a point which does not lead directly to the washer nozzle. It is thereby prevented that washer fluid is fed in the form of a surge to the washer nozzle which is presently not to be supplied with washer fluid. According to various embodiments, the generation of a splash on the window which is not to be supplied with washer fluid is thereby prevented.

According to an embodiment, the pressure surge of washer fluid can be conducted into the inlet of the valve in a simple manner if at least one of the valve seats is arranged at an inlet which opens out from the dual pump into the valve. The valve body, during its movement, thereby presses washer fluid which is present upstream of the valve seat into the inlet and therefore in the direction of the dual pump.

According to another embodiment, the valve is of particularly simple structural design if the valve body is arranged on the center of a diaphragm.

An unintended delivery of washer fluid to the washer nozzles can, according to yet another embodiment, be kept particularly low if the inlets of the valve are arranged so as to taper toward one another and are directed at the center of the valve body.

To further reduce the unintended delivery of washer fluid, according to yet another embodiment, it is conducive if at least one of the outlets of the valve is connected to an annular calming duct and if the calming duct surrounds the valve seat. The washer nozzles are thereby supplied with washer fluid from the calming duct. Pressure surges which are generated in the valve are substantially prevented from propagating in the direction of the washer nozzle as a result of the annular design of the calming duct.

A pressure surge which is generated by the valve body is, according to another embodiment, reliably conducted past the valve seat if the valve body is guided so as to be movable transversely with respect to the valve seat. By means of said design, a flow of washer fluid generated by the dual pump is cut off by the movement of the valve body, which further reduces possible pressure surges in the washer fluid line which leads to the washer nozzle.

According to another embodiment, the valve is of particularly simple structural design if the valve seat is arranged on a tube piece which projects into the valve and which has a closed base, and if the valve body annularly surrounds the tube piece.

According to another embodiment, during the movement of the valve body, the delivery of the washer fluid to the washer nozzle is uniformly throttled if the valve body tightly surrounds the tube piece and is guided so as to be movable between a position in which the valve seat is opened and a position in which the valve seat is covered.

According to another embodiment, to further reduce an impulse which is directed into the outlet of the valve, it is conducive if the tube piece which projects into the valve has an encircling ramp as a valve seat.

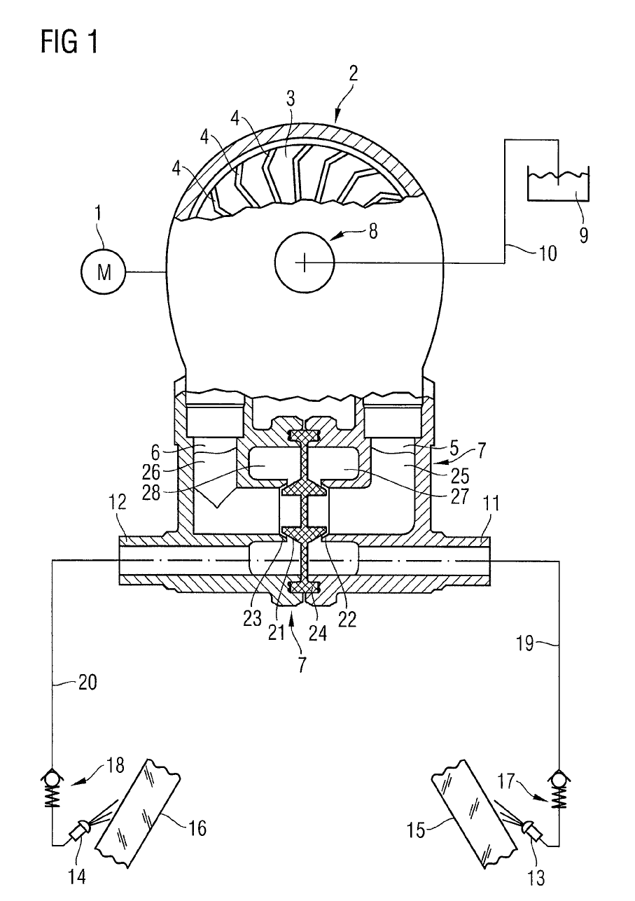

FIG. 1 shows a window cleaning system for a motor vehicle, having a dual pump 2 which can be driven in two rotational directions by an electric motor 1. The dual pump 2 has a rotor 3 with guide blades 4 and has two outlet ducts 5, 6 at which a valve 7 is arranged. A suction duct 8, which is arranged centrally with respect to the rotor 3, of the dual pump 2 is connected to a washer fluid line 10 which leads to a storage tank 9. The valve 7 has two outlets 11, 12 at which in each case one washer nozzle 13, 14 is arranged. The washer nozzles 13, 14 are arranged in front of different windows 15, 16, for example a front window and a rear window of the motor vehicle. Non-return valves 17, 18 are arranged directly upstream of the washer nozzles 13, 14, which non-return valves 17, 18 prevent washer fluid lines 19, 20, which connect the washer nozzles 13, 14 to the outlets 11, 12 of the valve 7, from running dry.

The valve 7 has a valve body 21 which is movable between a first valve seat 22 and a second valve seat 23. In the event of the dual pump 2 being driven such that the rotor 3 rotates counterclockwise, the valve body 21 is pressed firmly against the first valve seat 22 and washer fluid is fed from the storage tank 9 through the second valve seat 23 to the one washer nozzle 14. If the dual pump 2 is driven in the opposite direction, the valve body 21 is pressed against the second valve seat 23 and washer fluid is fed to the other washer nozzle 13.

However, during the movement of the valve body 21 as a result of a change in the rotational direction of the rotor 3 of the dual pump 2, a pressure surge is generated which, as a result of the design of the valve 7, is conducted into the dual pump 2. The valve body 21 of the valve 7 is arranged in the center of a diaphragm 24. The valve seats 22, 23 are arranged on inlets 25, 26, which are connected to the outlet ducts 5, 6 of the dual pump 2, of the valve. Therefore, during the switch of the valve 7 as a result of a change in rotational direction of the dual pump 2, the greatest movement of the diaphragm 24 takes place at the valve body 21, such that washer fluid displaced by the diaphragm 24 is conducted to the dual pump 2. Outlets 11, 12, which are provided for connecting the washer fluid lines 19, 20, of the valve 7 are arranged in each case at annular calming ducts 27, 28. The calming ducts 27, 28 surround the valve seats 22, 23.

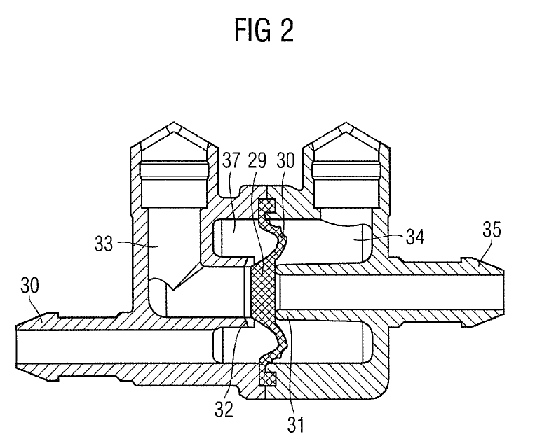

FIG. 2 shows a further embodiment of the valve 7 which differs from that of FIG. 1 in that a valve body 29 bears against a first valve seat 31 as a result of the internal tension of a diaphragm 30. The valve body 29 is situated opposite a second valve seat 32 with a spacing. The second valve seat 32 is arranged at an inlet 33 which is connected to the dual pump 2, while the other inlet 34 opens out upstream of the diaphragm 30. The first valve seat 31 is arranged at a first outlet 35 which leads to a washer nozzle 13, while the second outlet 36, as in the valve from FIG. 1, is connected to an annular calming duct 37. The second outlet 36 is preferably connected to a washer nozzle 14 which is arranged in front of the front window, and the first outlet 35 is preferably connected to a washer nozzle 13 which is arranged in front of the rear window of the motor vehicle.

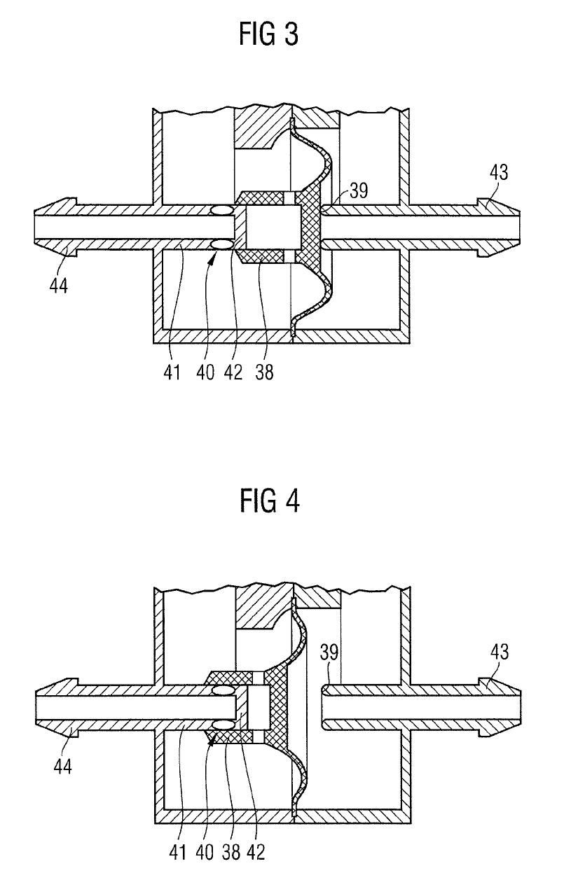

FIG. 3 shows a further embodiment of the valve 7 having a valve body 38 and a first valve seat 39 and a second valve seat 40, in which valve 7 a valve body 38 is guided transversely with respect to the second valve seat 40. The second valve seat 40 is arranged on the wall of a tube piece 41 which projects into the valve 7. The tube piece 41 has a closed base 42 and is tightly surrounded by the valve body 38. The valve seats 39, 40 are arranged at outlets 43, 44 which lead to the washer nozzles 13, 14. During the movement of the valve body 38 as a result of the dual pump 2 from FIG. 1 being driven, the valve body 38 is pushed over the tube piece 41 and closes off or opens the second valve seat 40.

FIG. 4 shows the valve 7 from FIG. 3 in the position in which the second valve seat 40 is closed off. The left-hand side of the valve 7 is of the same construction as that from FIG. 2. The valve 7 may of course also be of symmetrical design.

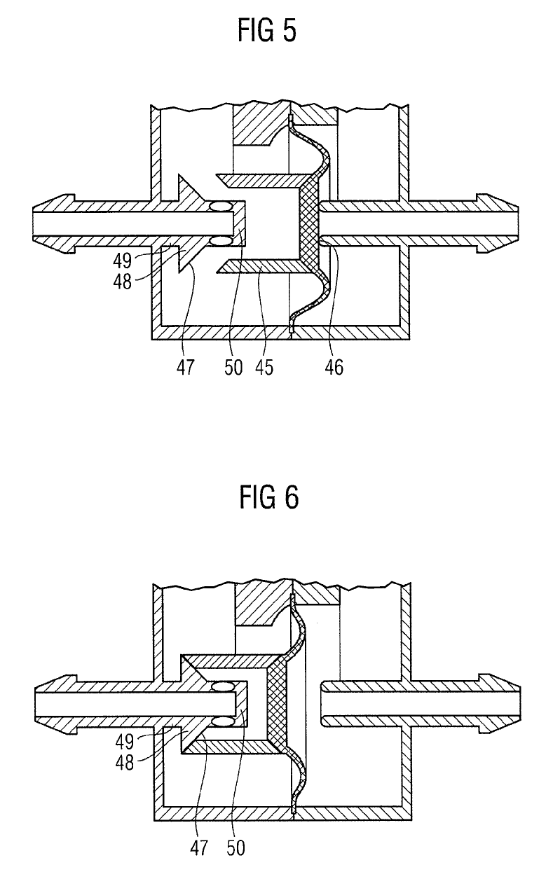

FIG. 5 shows a further embodiment of the valve 7 with a movable valve body 45, a first valve seat 46 and a second valve seat 47. The valve 7 differs from that from FIG. 3 in that the second valve seat 47 is arranged on an encircling ramp 48. The ramp 48 is arranged on a tube piece 49 which projects into the valve 7. The tube piece 49 has a closed base 50. The valve body 45 surrounds, with a spacing, that end of the tube piece 49 which projects into the valve 7. During a movement of the valve body 45 as a result of the change in rotational direction of the dual pump 2, the free end of the valve body 45 moves against the ramp 48, as illustrated in FIG. 6. Two outlets 51, 52 of the valve 7 serve to connect the washer fluid lines 19, 20 illustrated in FIG. 1. The left-hand side of the valve 7 is of the same construction as that from FIG. 2. The valve 7 may of course also be of symmetrical design.

What is claimed is:

1. A window cleaning system for windows of a motor vehicle, comprising
a dual pump which is operable to be driven in two rotational directions and having a valve which has a valve body which is operable to be moved between two valve seats,
two washer fluid lines which are connected to the valve and which lead to washer nozzles,
wherein the window cleaning system is operable depending on a function of the rotational direction of the dual pump to select between a first window to be sprayed with washer fluid via the one washer nozzle and a second window to be sprayed with washer fluid via the other washer nozzle,
and wherein an impulse, which is generated during the movement of the valve body within the washer fluid situated in the valve, is directed away from the outlet.

2. The window cleaning system according to claim 1, wherein at least one of the valve seats is arranged at an inlet which opens out from the dual pump into the valve.

3. The window cleaning system according to claim 1, wherein the valve body is arranged on the center of a diaphragm.

4. The window cleaning system according to claim 1, wherein the inlets of the valve are arranged so as to taper toward one another and are directed at the center of the valve body.

5. The window cleaning system according to claim 1, wherein at least one of the outlets of the valve is connected to an annular calming duct and the calming duct surrounds the valve seat.

6. The window cleaning system according to claim 1, wherein the valve body is guided so as to be movable transversely with respect to the valve seat.

7. The window cleaning system according to claim 1, wherein the valve seat is arranged on a tube piece which projects into the valve and which has a closed base, and the valve body annularly surrounds the tube piece.

8. The window cleaning system according to claim 7, wherein the valve body tightly surrounds the tube piece and is guided so as to be movable between a position in which the valve seat is opened and a position in which the valve seat is covered.

9. The window cleaning system according to claim 7, wherein the tube piece which projects into the valve has an encircling ramp as a valve seat.

10. A method for distributing fluid within window cleaning system for windows of a motor vehicle, comprising the steps of:
driving a pump in a first rotational directions, wherein the pump comprises a valve which has a valve body which is operable to be moved between two valve seats and wherein said valve body is moved to the first valve seat and said pump delivers fluid to a first outlet;
driving the pump in a second rotational directions
wherein said valve body is moved to the second valve seat and said pump delivers fluid to a second outlet, and
wherein the valve is arranged within said pump in such a way that during a transitional movement of said valve body from the first valve seat to the second valve seat fluid is not being forced out of the first outlet.

11. The method according to claim 10, comprising the step of arranging at least one of the valve seats at an inlet which opens out from the pump into the valve.

12. The method according to claim 10, comprising the step of arranging the valve body on the center of a diaphragm.

13. The method according to claim 10, comprising the step of arranging the inlets of the valve so as to taper toward one another and are directed at the center of the valve body.

14. The method according to claim 10, comprising the step of connecting at least one of the outlets of the valve to an annular calming duct wherein the calming duct surrounds the valve seat.

15. The method according to claim 10, comprising the step of guiding the valve body so as to be movable transversely with respect to the valve seat.

16. The method according to claim 10, comprising the step of arranging the valve seat on a tube piece which projects into the valve and which has a closed base, wherein the valve body annularly surrounds the tube piece.

17. The method according to claim 16, comprising the step of guiding the valve body which tightly surrounds the tube piece so as to be movable between a position in which the valve seat is opened and a position in which the valve seat is covered.

18. The method according to claim 16, wherein the tube piece which projects into the valve has an encircling ramp as a valve seat.

19. A window cleaning system for windows of a motor vehicle, comprising:
a pump operable to be driven in a first rotational directions, wherein the pump comprises a valve which has a valve body which is operable to be moved between two valve seats and wherein said valve body is moved to the first valve seat when said pump is driven in said first rotational direction and delivers fluid to a first outlet;
wherein the pump is further operable to be driven in a second rotational directions wherein said valve body is moved to the second valve seat and said pump delivers fluid to a second outlet, and wherein the valve is arranged within said pump in such a way that during a transitional movement of said valve body from the first valve seat to the second valve seat fluid is not being forced out of the first outlet.
